(19) United States
(12) Patent Application Publication
(10) Pub. No.: US 2009/0317530 A1
(43) Pub. Date: Dec. 24, 2009

(54) PROTEIN-RICH PREMIX POWDERS COMPRISING OKARA FOR HEALTHY FOOD INDUSTRY

(76) Inventors: Ilan Rotem, Lapid (IL); Nava Almog, Ra'anana (IL)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/066,253

(22) PCT Filed: Sep. 11, 2006
(86) PCT No.: PCT/IL06/01065

§ 371 Date: Oct. 24, 2008

Related U.S. Application Data
(60) Provisional application No. 60/716,516, filed on Sep. 14, 2005.

(51) Int. Cl. A23L 1/305; A21D 13/00; A21D 2/00; A21D 10/00; A21D 13/06; A21D 2/26; A21D 4/00; A23L 1/10; A23L 1/325; A23L 1/317; A23L 2/66; A23L 1/16

(52) U.S. Cl. 426/550; 426/634; 426/473; 426/392; 426/507; 426/472; 426/431; 426/504; 426/451; 426/508; 426/618; 426/620; 426/643; 426/646; 426/598; 426/559; 426/560; 426/557

(57) ABSTRACT

A stable okara concentrate is provided, being a protein-rich powder to be used in producing healthy foodstuffs, enriched in proteins, dietary fibers, and free of cholesterol, essentially consisting of natural materials not contacted with any toxic or harmful substances during their production. Useful premixes for use in food industry or household are also provided. The concentrate may be made from a by-product obtained in soybeans processing. Food products comprising the okara concentrate are also provided.

### FIELD OF THE INVENTION

The present invention relates to the food manufacture utilizing okara obtained as a by-product in the soymilk production. Particularly, the invention provides powder premixes, based on okara, containing soybean nutrients, stable in storage and easy to manipulate, to be industrially used in producing healthy foodstuffs, enriched with proteins, dietary fibers, and lysine, free of cholesterol, lactose, milk proteins, and soy toxic and harmful components, which foodstuffs, e.g. bakery and pasta, essentially consist of natural materials and have not been contacted with any toxic or harmful substances during their production.

### BACKGROUND OF THE INVENTION

Humans have always covered part of their energy and nutrient needs by including in their diet various seeds, of which importance still increased as hunting and gathering was replaced by organized agriculture more than 10,000 years ago. Nowadays, the seeds may constitute even more than 80% of the daily caloric intake in some regions, wherein rice, maize and wheat provide about two thirds of world's food energy intake. The evolution of genetic and metabolic constitution has not kept up with revolutionary cultural changes affecting the human diet, and many essential nutrients must be supplied from additional sources. The protein content of rice, maize and wheat, grasses of class Liliopsida of division Magnoliophyta, is only 7, 10 and 13%, respectively, and when the diet is not enriched by proteins from fish or meat, deficiency disorders, such as kwashiorkor, appear. In addition to economic reasons, protein deficiency may result from cultural reasons, among which popularity of special diets, including vegetarianism, prevail. Relatively low protein content in cereals might be partially complemented by including in the diet legumes—also seeds but with higher protein content. Soybeans, legumes of class Magnoliopsida of division Magnoliophyta, nowadays the most popular of legumes, contain more than 40% protein.

Soybean, a traditional material of Eastern Asian kitchen, has spread in Western countries since the beginning of the twentieth century, as a protein-enriching or taste-enriching additive, and in substituting for meat or milk food products. The world production of soybean was more than 200 million tons in 2005, the U.S.A. being the largest producer. Soybean might become the largest plant source of proteins (rice, maize, or wheat had a production of somewhat more than 600 million tons each in 2005 but they contain three to six times less protein than soybeans), its current production theoretically being capable of supplying the required daily protein portion for every world inhabitant. However, only a smaller part of the soybean protein has been utilized in the human nutrition so far, the soybean being mostly employed in oil production, soybean oil becoming the world's leading edible oil, and the residue after the oil extraction being mostly used in animal feeds in producing poultry, meat, milk, and eggs.

In view of the increasing awareness of the risks associated with the consumption of saturated fats and cholesterol, and in view of the increasing demand for non-animal proteins, the potential of the soybean products is still more recognized, and it is therefore an object of the invention to provide an all-natural product for improving protein balance in food products. Whole soybeans contain usually, based on the dry weight, 40% protein, 35% carbohydrate, and 20% lipid, the moisture being about 12%. The beans, on one hand, contain most of required nutrients, including essential fatty acids and essential amino acids, with relatively high amount of lysine, and providing also other useful materials, but on the other hand, they contain biologically active components, not necessarily desirable in food, such as enzyme inhibitors or phytoestrogens, and toxic carbohydrates causing flatulence. Therefore, the direct consumption of untreated beans is avoided. Furthermore, soybean products often exhibit bitterness and unpleasant “beany” flavor or taste.

As mentioned above, a major part of the soybean production is processed by the oil industry, usually including the extraction with hexane followed by the utilization of the defatted residue as animal feeds, or for making defatted soy flour. A minor part of soybean production is employed for manufacturing special products, such as full-fat soybean flour and soy protein concentrates. Soy protein concentrates or isolates, used as food additives, are made by extracting off the sugars to enrich the final material with proteins, wherein the extraction employs various chemicals, such as acids, hydroxides, and lower alcohols. The extractions, whether oil extraction or sugar extraction, comprise various chemicals that might be objected to by the ever-growing market for “chemically free” foodstuffs, and, besides, employing chemicals, even if non-toxic, such as hydroxide, may lead to harmful reactions or reactions lowering the product quality, an example being the destruction of the essential cysteine, and the formation of potentially toxic lysinoalanine, when subjecting proteins to an alkaline environment. It is therefore another object of the invention to provide a protein-enriched product which is obtained without using toxic or harmful chemicals. The said full-fat soybean flour is made of dehulled, heat-treated beans without oil extraction, and is used in bakery industry, but it is too fatty to be used as a protein additive, and, besides, it may comprise the mentioned naturally occurring toxic components. The present invention aims at a nontoxic protein additive, in one aspect with lowered lipid content, preferably utilizing residual material after the manufacture of a soy lipid product.

An important soy product on the market is soymilk, a water extract of whole soybeans, which may be adjusted to mimic cow milk, and may be used as a substitute for cow milk to be used by persons suffering from metabolic or allergic disorders associated with cow milk proteins or sugars. There are many technologies for soymilk production, including various steps comprising dehulling, deactivating lipooxygenases, removing flatulence-causing saccharides, removal of sedimentable solids, etc. The milk may be further used for making milk-like products, including bean curds, called tofu. The residual solids, removable by centrifugation (see, e.g., U.S. Pat. No. 4,307,118), are called okara. Okara, containing about 37% of the original soy proteins, is processed for animal feeds. It is a further object of the invention to utilize okara, which is a soybeans-processing by-product, for manufacture of an industrially usable protein-enriched additive, lysine rich, cholesterol-free, free of lactose, free of mammalian milk allergens, and prepared from soybeans without extractions that use strong bases, acids, and organic solvents. U.S. Pat. No. 4,505,942 relates to a cake-like sheet base for making snack food, comprising okara, flour, and starch, the okara constituting from about 26 to about 38%, the sheet being dried down to a water content of 13-20%. U.S. Pat. No. 5,128,165 relates to a method for preparing baked goods comprising okara powder, baking powder, and eggs in amounts from 3 to 5 parts of egg fluid for one part of the okara powder. Freshly obtained okara is unstable, and, beside exhibiting or easily acquiring the beany flavor that is mostly perceived as unpleasant, it gets quickly spoiled and sour due to microbial growth and its own enzymes.

U.S. Pat. No. 6,541,058 discloses a process for producing stable okara by sterilizing wet okara, containing at least 70% water, followed by cooling and aseptically sealing it. US 2006/0062890 describes a process in which okara without strong beany odor is obtained, by including an atmosphere of carbon dioxide when processing soybeans and obtaining okara. U.S. Pat. No. 6,235,337 discloses a method for producing soymilk and tofu wherein low oxygen level is assured during the milk extraction. US 2006/0034977 provides food products comprising wet okara having been processed in a nitrogen atmosphere or under vacuum at lower temperatures. It is a still further object of the invention to provide a process for preparing an okara-based product, which has a long-term storage stability at room temperature, which may be used in an industrial production of food being enriched in protein and lysine, and being free of chemicals and mammalian milk components, wherein the process comprises drying okara, optionally after its storing at lower oxygen concentration.

Other objects and advantages of present invention will appear as description proceeds.

### SUMMARY OF THE INVENTION

This invention provides a powdered, protein-rich concentrate for preparing healthy food and meal. Provided is an okara concentrate passing through a 70-mesh standard screen, comprising i) dried milled okara obtained from whole fresh soybeans after soy milk removal, preferably after separation from said milk by centrifugation; ii) a gluten-donor containing at least 10 wt % of dry gluten; and iii) water in an amount of from 3 to 15 wt %; and wherein the ratio gluten/okara in the mixture is from 1/12 to 1/3, based on dry weights. Said concentrate contains soybean proteins in an amount of from 10 wt % to 30 wt %, and total proteins in amount of from 15 to 50% wt %. In a preferred embodiment of the invention, the gluten/okara ratio in said concentrate is about 1/10. In another preferred embodiment, said ratio is about 1/3.

Said gluten-donor is selected from gluten concentrates, flours, and mixtures thereof, wherein said flour may be selected from wheat, oats, rye, barley, and their mixtures. Said concentrate is usually a freely-flowing light powder without beany flavor and bitter taste. The concentrate of the invention is free of cholesterol and free of lactose. The concentrate, comprising usually more than 1 wt % lysine, is suitable for enriching the diet with lysine, or for complementing cereal proteins, which are relatively poorer in lysine. The concentrate of the invention, in sharp contrast to wet untreated okara, was found to be stable even at room temperature during prolonged storage, and, being a free-flowing powder, is an ideal stock of concentrated healthy protein and other useful nutrients, easy to manipulate and use, ready for use in industrial production of foodstuffs.

The invention is directed to an okara concentrate for industrial use as a source of soy bean components, devoid of naturally occurring soy bean toxic components, for the production of chemical-free healthy food that is also lactose-free, cow milk allergen-free, and cholesterol-free, wherein said components include proteins, essential amino acids, particularly lysine, dietary fibers, and vitamins.

The invention further provides a process for preparing an okara concentrate, comprising i) providing a raw material of wet okara; ii) drying said wet okara at a temperature of from 70 to 110° C., preferably from 80 to 100° C., to reach a moisture of 3 to 15 wt %, wherein the conditions of heat and mass transfer must enable to achieve said moisture within no more than 4 hours, thereby obtaining a material of dried okara; iii) adding a powdered gluten-donor to said material of dried okara in an amount providing a mass ratio gluten/okara of from 1/12 to 1/3, based on dry weights, wherein said gluten-donor is a material containing not less than 10 wt % gluten and not more than 15% water; iv) milling said material of dried okara, either without or with said gluten donor to provide a powder that passes a standard 70 mesh sieve; and v) homogenizing a mixture of said material of dried okara and said gluten-donor; wherein said step iii) may be performed after said step iv) if said gluten-donor is in the form of a powder that passes a standard 70 mesh sieve. Said step of providing wet okara preferably comprises preparing soymilk from healthy whole soybeans, i.e., the wet okara is preferably obtained as a by-product of soymilk production, or in a technology similar to the technology of soymilk production. Preferably said material of wet okara is the sediment obtained after the separation of said milk by centrifugation. In one aspect of the invention, said step of drying is employed immediately after obtaining said material of wet okara. In another aspect of the invention said step of drying is employed after storing said material of wet okara at a temperature below 10° C., and preferably below 5° C., under conditions of lower partial oxygen pressure; wherein the fresh wet okara obtained as said sediment is cooled and packaged at a temperature below 10° C., and preferably below 5° C., under conditions of lower partial oxygen pressure, and then stored, waiting for future drying to produce the okara concentrate of the invention, or to be used wet as an admixture in foodstuffs, possibly together with the okara concentrate of the invention. Said lower partial oxygen pressure may be achieved by lowering total gas pressure or by diluting the oxygen by other gases. The process for making the concentrate of the invention, thus, comprises water extraction of sound, dehulled, ground soy beans, employing heating—usually at temperatures between 95 and 120° C., separating okara by centrifuging, drying at 70-110° C., mixing with a gluten-donor material, and milling to achieve 70-mesh particle size.

The invention is also directed to a powdered premix comprising the okara concentrate, as described, together with other components selected from the group consisting of flour, gluten, starch, baking powder, calcium bicarbonate, seeds, soy protein concentrate or isolate, dried soy milk, sucrose, sweetener, dried yeast, spices, and flavors. In a preferred embodiment of the invention, said powdered premix comprises said okara concentrate and dried soy milk, which mixture reunites and complements soy proteins, separated during the milk and okara production, but without the naturally occurring toxic soy components which have been removed, and further in the concentrated, powdered form, rendering the premix an ideal protein source. The invention is directed to the use of an okara concentrate according to the invention, and to the use of an okara premix according to the invention, as a base for manufacturing food products, or as an additive enriching food products with proteins, dietary fibers, or with soy components. The okara concentrate of the invention is intended for use both in food industry and in household in preparing baked or cooked, or otherwise prepared, products and meals.

The invention relates to the use of the above okara concentrate in manufacturing healthy food products, wherein the use comprises i) a step of mixing said concentrate with water and with another component in a mass ratio of from 1/10 to 10/1, wherein said component is selected from the group consisting of flour, gluten, starch, seeds, dried soy milk, and a mixture thereof; ii) optionally a step of adding an amount according to the need of a component selected from the group consisting of baking powder, calcium bicarbonate, sucrose, sweetener, dried yeast, spices, flavors, preservatives, and any mixture thereof; and iii) a step selected from baking, cooking, and drying, or their combinations. Said step iii) may comprise other types of heat treatment, such as frying, etc. Said water may be partially replaced by wet food products, such as for example wet okara. The okara concentrate of the invention is a versatile component in manufacturing nutritionally balanced food blends. The okara concentrate may be used in manufacturing various baked or boiled or dried or other products, in which it is desirable to increase the protein content, to lower the carbohydrate content, and/or which are intended to be marketed as healthy products, and/or products for lactose-intolerant and/or cow milk-allergic people, and/or for vegetarian-diet, and/or when meat or cow milk are to be substituted for; the products being selected from, but not limited to, the group consisting of bread, pastries, bagels, snacks, crackers, granola bars, energy bars, tortillas, pasta, cereal products, pancakes, waffles, patties, meatballs, sausages, fish sticks, and beverages. Also premixes comprising the okara concentrate, mixed with other components necessary for intended purposes, and other additives adjusting the texture, appearance, and taste, are intended for use in manufacturing foodstuffs selected from the above mentioned group of products. The invention may help in manufacturing meat product mimetics.

The invention also provides food products comprising the okara concentrate prepared according to the invented method, wherein the products may be selected from mixes and premixes to be used as raw materials or intermediates in further production, or they may be selected from the product for direct consumption, such as bread, bagels, snacks, crackers, granola bars, tortillas, pasta, cereal products, patties, meatballs, sausages, fish sticks, and beverages.

In a preferred embodiment, food products according to the invention comprise, but without being limited to, Okara Crackers which are prepared by baking a paste consisting of about 30 wt % of the okara concentrate with gluten/okara ratio of 1/3, about 20-25 wt % flour, e.g. wheat flour, additives such as salt and sugar, and about 45 wt % water. In other preferred embodiment, the food product is Okara Bagels, which bagels are prepared by baking a paste consisting of about 30 wt % of the okara concentrate with gluten/okara ratio of 1/3, about 23 wt % wheat flour, about 46 wt % water, about 0.5 wt % sugar, salt, and yeast.

### DETAILED DESCRIPTION OF THE INVENTION

It has now been found that okara can be processed to provide an okara concentrate as a stable material to be easily stored and manipulated, and finally used for industrial production of high quality healthy food. An okara concentrate according to the invention is preferably prepared from okara obtained after soymilk production, usually as a wet sediment after centrifugation. A process for manufacturing the okara concentrate of the invention comprises a step of drying wet okara, a step of mixing powdered okara and powdered gluten-donor, and a step of milling a powder comprising okara. The process of the invention comprises drying wet okara at a temperature of from 70 to 110° C. to achieve a moisture of 3 to 15 wt %, wherein the conditions of heat and mass transfer are adjusted to enable to achieve said moisture within no more than 4 hours. The term moisture and the term water content are used interchangeably throughout the application. A rich mixture of nutrients present in okara is concentrated by said drying step, but without causing deleterious changes that may occur at temperatures higher and water contents lower than used. In the process of the invention, any time interval between said obtaining wet okara and said drying may pass, if no microbiological or biochemical processes occur that deteriorate the organoleptic properties of the material. In one embodiment of the invention, the drying step is employed immediately after separating wet okara from soymilk, possibly integrating the processes of milk production and okara production. In another embodiment of the invention the drying step is employed after storing wet okara at a temperature below 10° C., and preferably below 5° C., under conditions of lower partial oxygen pressure, wherein said lower partial concentration may be achieved by lowering total gas pressure or by diluting the oxygen by other gases, e.g. nitrogen. The process of producing an okara concentrate according to the invention further comprises mixing and homogenizing dried okara with a powdered gluten-donor (the term gluten-donor as used herein is to be taken to mean any edible substance which contains gluten in nutritionally sufficient quantities, preferably including donors that contain at least 10 wt % of dry gluten), so that the ratio gluten/okara in the mixture of from 1/12 to 1/3 is achieved, based on dry weights, wherein said donor contains at least 10 wt % of dry gluten, and not more than 15% water. Of course, care is taken not to bring to the mixture too much water or useless components, or material which might be microbiologically or chemically contaminated. The process of the invention comprises a step of milling and homogenizing, providing a powder that passes a standard 70 mesh sieve; repeated sieving and/or milling may be included to achieve said particle size. In one embodiment of the invention, said milling is performed with the mixture of powdered okara and powdered gluten donor; in another embodiment of the invention, powdered okara is milled and only then mixed and homogenized with powdered gluten donor, to provide a powder that passes a standard 70 mesh sieve. It has been found that the presence of particles larger than about 200 μm lowers the texture quality of the products, and complicates the preparation of dough and the manipulation therewith. The okara concentrate according to the invention is an easy to manipulate powder for industrial use, stable at the room temperature for long periods of time and suitable to be kept in large stock to be used anytime in the preparation of a variety of food products. In one aspect, the okara concentrate may be used directly when formulating dough and foods; in another aspect, the okara concentrate is used in the preparation of food premixes or ready-made mixes, either powdered or wet, which mixtures are an important aspect of the invention.

In one aspect, the okara concentrate may be used directly when formulating pastes and foods; in another aspect, the okara concentrate is used in the preparation of food premixes or ready-made mixes, either powdered or wet, which mixtures are a very useful aspect of the invention. The invention, thus, provides powders to be used, for example, as additives to enrich food products with soy nutrients, or to provide a ready paste/dough after mixing with water and spices.

The okara concentrate of the invention is preferably utilized for making foodstuffs for the healthy food market, and therefore, the wet okara used for making the okara concentrate of the invention is preferably obtained in a process which does not comprise potentially toxic or harmful chemicals, such as hexane used by some techniques for oil extraction, or hydroxide used by some techniques for carbohydrate extraction. Preferred is, therefore, the okara obtained during manufacturing soymilk from fresh soybeans which are not defatted, and furthermore, preferred is okara which is a by-product, thus adding value to a material otherwise fed to animals. However, the techniques involved in the invention may be used also for processing okara obtained in other processes, such as okara obtained from defatted beans, if the beans were defatted not by chemical extraction but by pressing. Alternatively, the okara may be produced from fresh beans in a process predominantly intended for making okara of high quality, all other products becoming by-products. The soybeans used for manufacturing the okara concentrate of the invention are preferably sound beans, not having been affected by a plant disease or a parasite, or infected by a microbial infection before or after harvest. In a preferred embodiment, the beans used for manufacturing the okara concentrate of the invention are obtained by organic farming.

In a preferred embodiment of the invention, an okara concentrate is provided, having gluten/okara ratio of 1/11, based on dry weights, corresponding to about 9% gluten content. Such concentrate may be mixed with pastry flour, to replace any desired part of the pastry flour, and be used in the preparation of pastries.

In another embodiment, the gluten/okara ratio of the okara concentrate is 1/7, and the concentrate is used to substitute for a desired part of bread flour in making bread-like bakery products enriched with soy nutrients. In a preferred embodiment, an okara concentrate is mixed with flour to provide a powdered premix to be used immediately after mixing with water and, optionally, with spices and additives; however, the spices and additives may be admixed to the concentrate with flour to make the mixture ready for use after adding water. Said additives may comprise baking powder, flavors, vitamins, salts, essential nutrients, etc.

The invention provides a powder premix for preparing Okara Flakes, containing flour and an okara concentrate having a gluten/okara ratio of from 1/9 to 1/7, wherein the concentrate constitutes from 50-66% of the premix mass, and wherein the flour may be selected from wheat, corn, oat, and rice. The premix may optionally comprise additives selected from baking powder, sugar or sweetener, salts, spices, and flavors. When preparing the Flakes, the premix is stirred with water added in an amount of from 12 to 54% of the premix mass, and baked or dried, wherein for baking more water is added than for drying.

The invention further provides powder premixes for preparing food products enriched with soy nutrients. In one embodiment, the invention provides a powder premix for preparing Okara Bagels, containing wheat flour and an okara concentrate having a gluten/okara ratio of about 1/3 (denoted as OC 1/3 hereinafter), wherein the concentrate constitutes from 40 to 60% of the premix mass, the premix optionally comprising additives selected, for example, from dried yeast, salts, spices, and sugar. When preparing the Bagels, the premix is stirred with water added in an amount of about 45% of the premix mass, additives are added if not already present, and the mixture is shaped and baked. In other embodiment, the invention provides a powder premix for preparing Okara Pasta, containing wheat flour and concentrate OC 1/3, wherein the concentrate constitutes from 25 to 35% of the premix mass. When preparing the pasta, the premix is stirred with water added in an amount of about 53% of the premix mass, and the mixture is shaped and dried.

The powdered okara concentrate, preferably containing higher concentration of the nutrients than the original wet okara, may enrich food products with the nutrients, without negatively affecting other features associated with their quality. When using the concentrate, in replacing other components or substituting for a part thereof, or when preparing a paste, such as for bread or macaroni, the concentrate is used in such a way that the quality of both the products and intermediates is essentially unaffected or increases. Important physical parameters characterizing the intermediates, such as pastes/doughs, were checked and found satisfying, including rheological properties, water uptake, extrusion behavior, as well as parameters characterizing the products, including taste, texture, appearance. The premixes of the invention suitable for use in industry and household. The premixes and ready-made mixes comprising the okara concentrate of the invention are formulated for a host of applications and products. In a preferred embodiment, a stable homogeneous powder containing the okara concentrate and comprising important nutrients may be stored at room temperature for long periods of time, or for still longer time periods in a dry cool environment, which powder further comprises another source of proteins or fats or carbohydrates, and may be enriched by additional salts, vitamins, or essential nutrients. In a preferred embodiment, said source comprises dried soymilk. In another preferred embodiment said source comprises starch. Said protein concentrate may comprise a soy protein concentrate or isolate. The okara concentrate of the invention, as well as mixes and premixes comprising same, provide a flexible tool in manufacturing healthy food products. A skilled person will use the concentrate and the premixes as building blocks for achieving any desired combination of the involved nutrients, combining these powders with a powder of gluten, flour, starch, etc. The powders of the invention will enrich said healthy food products with protein, calcium, essential amino acid, particularly lysine, and will ensure that said products be lactose-free, cow milk allergens-free, and cholesterol-free, wherein said products may comprise bread, bagels, snacks, crackers, granola bars, tortillas, pasta, cereal products, patties, meatballs, sausages, fish sticks, and beverages, such as fortified juices.

The invention is directed to the use in food production of an okara concentrate, comprising okara, gluten in an amount of from about 8.3 to about 33.3 wt % based on dry okara, and water in an amount of from 3 to 15%, wherein the okara is obtained from a sediment after preparing soymilk, further it is subjected to drying at 80-100° C. for 4 hours or less, it is homogenized with a gluten-donor, and it is milled to obtain particle size not greater than 70 mesh. The okara concentrate contains soybean nutrients, including soy proteins, dietary fibers, essential amino acids, particularly lysine, essential fatty acids, carbohydrates, vitamins, calcium, etc. The concentrate does not contain naturally occurring toxic components or potentially harmful biologically active components of soybeans, nor has the concentrate contacted toxic or harmful chemicals during its whole production procedure. The conditions of okara separation and processing exclude formation of potentially harmful chemical compounds, and eliminate undesired reactions, such as Maillard reaction, etc. Moreover, the okara concentrate, although containing proteins and fats, does not contain animal fats and cholesterol, involved in many health problems. Therefore, the okara concentrate is suitable for producing healthy food products, still more popular among the consumers. The absence of cow milk components makes the okara concentrate also non-allergenic for many consumers suffering from cow milk allergy, and also safe for lactose-intolerant consumers. Said gluten is provided in the okara concentrate by any gluten-donor, selected from gluten concentrate or isolate, or flour selected from wheat, barley, oat, and rye flour. A skilled person will understand that a donor with lower gluten content, such as wheat type having 8% dry gluten will have to be added in higher mass than raw gluten containing 80% dry gluten to achieve a certain okara/gluten ratio, and said person will easily calculate the masses of raw materials to be mixed. In one aspect of the invention, the okara concentrate to be used in food production may contain okara, gluten concentrate or isolate, and water; for example, when aiming at ratio gluten/okara to be 1/10, the weights of the components (okara+gluten+water), in gram per 100 gram, may be 83+8+9. In another aspect, the okara concentrate may contain okara, flour containing 10% gluten, and water; for example, when aiming at ratio gluten/okara to be 1/10, the ratio of the components (okara+flour+water), in gram per 100 gram, may be 45+46+9. Usually, the okara concentrate will contain from about 7 to about 33% soy protein, preferably from 10 to 30% soy protein, and from about 13 to about 50% total protein. Said gluten-donor will usually contain gluten in an amount of from 10 to 80 wt %. In a preferred embodiment, the concentrate will contain a mixture of dried okara with gluten and flour. The use of the okara concentrate according to the invention comprises preparing premixes to serve as a base for manufacturing food products or for enriching food products with proteins or lysine, dietary fibers, or other soy nutrients. The use of the invention comprises preparing stable ready-made premixes requiring only the addition of water, or intermediate mixtures being further mixed with additional components. The okara concentrate of the invention, and premixes and ready-made mixes containing it, are used with advantage in manufacturing bread, bagels, snacks, crackers, granola bars, tortillas, pasta, cereal products, patties, meatballs, sausages, fish sticks, and beverages.

Soybeans comprise many nutritious proteins and lipids, which are partitioned among various fractions during soybean processing, most of the useful components being divided between soymilk and okara. Harmful components are either neutralized or removed in whey, for example toxic carbohydrates. Combining okara with soymilk would reconstitute the most of soy materials without the harmful ones. It is a preferred embodiment of the invention to use the okara concentrate in manufacturing a food product by mixing the concentrate with soymilk. One of preferred premixes of the invention comprises the okara concentrate and dried soymilk. In another preferred embodiment, the okara concentrate is used for preparing the food products by further including in the product dried soy bean protein concentrate or isolate. The okara concentrate is used in manufacturing nutritionally balanced food blends, or as replacement for nonfat milk solids. In a preferred embodiment, the okara concentrate is used in manufacturing mimetic meat products.

The invention provides a process for producing an okara powder concentrating many soy nutrients without containing toxic or harmful compounds, which process comprises i) obtaining okara as a wet sediment after removing soymilk; ii) drying wet okara at temperatures of from 70 to 110° C. for 4 hours or less to lower the water content to 3 to 15 wt %, wherein said wet okara may be dried immediately after obtaining it or after prolonged storage at a temperature below 10° C. under conditions of lower partial oxygen pressure; iii) adding to okara a gluten-donor containing at least 10 wt % gluten and homogenizing, wherein the amount of the donor is chosen so that the dry weight ratio gluten/okara is from 1/12 to 1/3 in the mixture, and water is from 3 to 15%; iv) milling a powder containing okara to provide a powder that passes a standard 70 mesh sieve; wherein steps iii) and iv) may be switched in time so that milled okara powder 70 mesh is mixed with gluten-donor powder of 70 mesh. The resulting freely flowing powder is easy to store and manipulate. In one embodiment of the invention, said wet okara may be dried after its prolonged storage, such as, for example, for three months at a temperature below 10° C. under conditions of lower partial oxygen pressure. Said resulting freely flowing powder may be stored for prolonged periods even at room temperature without losing its quality, when constant low humidity is provided. The storage period for said powder may be, for example, one year, or more when the storage temperature is from 4 to 10° C.

The invention will be further described and illustrated by the following examples.

### EXAMPLES

### Example 1

### Okara Preparation and Analysis

Okara, heat treated, obtained after soy milk production, was separated by means of centrifugation, and processed immediately or after storage at lower temperatures (about 4° C.) and at lower oxygen pressure (nitrogen). The wet okara was spread on belt conveyor and dried in hot air, about 90-110° C., taking less than 3 hours to reach about 10% moisture. The lumpy material was ground in a flour mill, obtaining fine powder passing through 70 mesh sieve. The particle size was completely below 210 μm.

The nutrient and energy contents were analyzed in food analytical laboratories. The analysis of a dried okara batch is presented in Table 1.

TABLE 1
Analytical values of a material of dried okara.

| Test | Results | |
|---|---|---|
| Moisture | 3.8 | wt % |
| Fat | 4.3 | wt % |
| Protein | 22.6 | wt % |
| Ash | 3.1 | wt % |
| Sucrose | 1.8 | wt % |
| Starch | 12.2 | wt % |
| Total Dietary fibers | 52.2 | wt % |

| | |
|---|---|
| Caloric value | 185 kcal/100 g |
| Na | 37.0 mh/100 g |

### Example 2

### Okara Concentrate

133 g wheat gluten which contains 75% protein and 9% moisture was mixed with 1000 g dry okara, containing 9% moisture, the mixture passing through a sieve of about 200 μm, providing a concentrate with gluten/okara ratio 1/10 (OC 1/10). Samples were stored at room temperature (20-30° C.) in closed bottles and checked for changes in analytical values, and for taste and olfactory and visual changes. The concentrate was stable, without any observable changes, for at least 12 months.

### Example 3

### Okara Flakes Cereal

425 g OC 1/10 (concentrate prepared in Example 1), 250 g soy flour, and 14 g baking powder were mixed with 325 g water and the dough kneaded to a uniform texture. The dough was crumbled into small pieces which were then rolled into thin flakes. The flakes were then placed in a 140° C. oven for about 30 minutes. The resulting product may be consumed as a breakfast cereal.

### Example 4

### Okara Sweetened Flakes Cereal

425 g OC 1/10, 250 g soy flour, 14 g baking powder and 50 g gluten were combined with 325 g water, and 30 g table sugar were then added (an equivalent amount of a heat stable intensive sweetener such as saccharine can be also used), and the dough kneaded to a uniform texture. The dough was crumbled into small pieces which were then rolled into thin flakes. The flakes were placed in a 140° C. oven for about 45 minutes. The resulting product may be eaten as a breakfast cereal.

### Example 5

### Okara Pasta

Concentrate OC 1/10 (38.7 wt %), semolina flour (57 wt %), calcium carbonate (0.3 wt %), and 90% soy protein isolate (4 wt %) were mixed together, shaped into the desired shape of the pasta pieces (extruder or press) and dried.

### Example 6

### Okara Bagels

30.5 wt % Okara concentrate according to the invention, whose gluten/okara ratio was 1/3 (OC 1/3) and moisture about 10 wt %, 22.9 wt % wheat flour, 45.8 wt % water, 0.2 wt % salt, 0.2 wt % yeast, and 0.4 wt % sugar were combined and mixed into uniform dough. The dough was inserted into an extruder to form the desired bagel shapes, then dipped in water with baking soda, coated with a desired flavor or coat (salt, sesame), and then baked in an oven.

### Example 7

### Okara Crackers

30.5 wt % OC 1/3 with a moisture of about 10 wt %, 22.9 wt % flour, 45.8 wt % water, 0.2 wt % salt, 0.2 wt % yeast, and 0.4 wt % sugar were combined and mixed into uniform dough. The dough was rolled to a thin layer, cut into desired shapes, coated by a desired coat (salt, sesame), and then baked in an oven.

### Example 8

### Okara Noodles

Noodles with a low carbohydrate content were prepared using an okara concentrate of the invention. The noodles were prepared without using flour. A mixture containing 60 g OC 1/10 (okara concentrate described in Example 1) was mixed with 16 g starch and water into uniform dough, rolled to a thin layer, dried, and cut into noodles. In another experiment 51 g OC 1/10 was mixed with 22 g starch and water into uniform dough, rolled to a thin layer, dried, cut into noodles, and boiled. The analysis showed 54.3 wt % and 45.8 wt % protein in the two batches, respectively. The second batch provided good, stable noodles, showing that the okara concentrate of the invention may be used for producing low carbohydrate, high protein, healthy noodles.

While the invention has been described using some specific examples, many modifications and variations are possible. It is therefore understood that the invention is not intended to be limited in any way, other than by the scope of the appended claims.

1. A powdered okara concentrate passing through a 70-mesh standard screen, comprising
i) dried milled okara;
ii) a gluten-donor containing at least 10 wt % of dry gluten; and
iii) water in an amount of from 3 to 15 wt %;
wherein the ratio gluten/okara in the mixture is from 1/12 to 1/3, based on dry weights, and wherein said dried okara is obtained by drying a material of wet okara which is a residue after soy milk extraction from sound soybeans.

2. A concentrate according to claim 1, wherein said material of wet okara is obtained as a sediment separated from said soy milk by centrifugation.

3. A concentrate according to claim 1, containing soybean proteins in an amount of from 10 wt % to 30 wt %, and total proteins in an amount of from 15 to 50% wt %.

4. A concentrate according to claim 1, wherein said gluten-donor is selected from gluten concentrates or isolates, flours, and mixtures thereof.

5. A concentrate according to claim 4, wherein said flour is selected from wheat flour, oats flour, rye flour, barley flour, and their mixtures.

6. A concentrate according to claim 1, being a powder without beany flavor or bitter taste.

7. A concentrate according to claim 1, being free of cholesterol.

8. A concentrate according to claim 1, being free of lactose and cow milk proteins.

9. A concentrate according to claim 1, containing at least 1 wt % lysine.

10. A concentrate according to claim 1, being stable during prolonged storage at room temperature.

11. A concentrate according to claim 1, being a stable, easy to manipulate powder for industrial use as a source of soy bean components which are devoid of naturally occurring soy bean toxic components, for the production of lactose-free, cow milk allergens-free, and cholesterol-free healthy food, wherein said components include proteins, dietary fibers, and essential amino acids, particularly lysine.

12. A process for preparing an okara concentrate, comprising
i) providing a material of wet okara;
ii) drying said wet okara at a temperature of from 70 to 110° C. to reach a moisture of 3 to 15 wt %, wherein the conditions of heat and mass transfer must enable to achieve said moisture within no more than 4 hours, thereby obtaining a material of dried okara;
iii) adding a powdered gluten-donor to said material of dried okara in an amount providing a ratio gluten/okara of from 1/12 to 1/3, based on dry weights, wherein said gluten-donor is a material containing not less than 10 wt % gluten and not more than 15% water;
iv) milling said material of dried okara, either without or with said gluten donor to provide a powder that passes a standard 70 mesh sieve; and
v) homogenizing a mixture of said material of dried okara and said gluten-donor;
wherein said step iii) may be performed after said step iv) if said gluten-donor is a powder that passes a standard 70 mesh sieve.

13. A process according to claim 12, wherein said step of providing wet okara comprises preparing soymilk from healthy whole soybeans, and wherein said material of wet okara is a sediment after the separation of said milk by centrifugation.

14. A process according to claim 12, wherein said step of drying is employed immediately after obtaining said material of wet okara.

15. A process according to claim 12, wherein said step of drying is employed after storing said material of wet okara at a temperature below 10° C., and preferably below 5° C., under conditions of a lower partial oxygen pressure.

16. A process according to claim 15, wherein fresh wet okara obtained as said sediment is cooled and packaged at a temperature below 10° C., and preferably below 5° C., under conditions of lower partial oxygen pressure, and then stored.

17. A process according to claim 15, wherein said lower partial concentration may be achieved by lowering total gas pressure or by diluting the oxygen by other gases.

18. A process according to claim 12, comprising
i) water extraction of sound, dehulled, ground soy beans, and heating at a temperature of from 85 to 120° C.;
ii) separating okara by centrifuging;
iii) drying at 70-110° C.;
iv) mixing with a gluten-donor material; and
v) milling to achieve 70-mesh particle size.

19. A powdered premix comprising an okara concentrate of claim 1 and another component selected from the group consisting of flour, gluten, starch, baking powder, calcium carbonate, whole or mined seeds, dried soy milk, sucrose, sweetener, dried yeast, spices, and flavors.

20. A powdered premix according to claim 19, wherein the component is dried soy milk.

21. A method of manufacturing food products, comprising mixing an okara concentrate according to claim 1 or an okara premix according to claim 19 with water and additives.

22. A method of manufacturing food products enriched with proteins, dietary fibers, or with soy components, comprising mixing an okara concentrate according to claim 1 or an okara premix according to claim 19, with water and other components.

23. A method of preparing food products and meals in industry or household, comprising i) a step of mixing an okara concentrate according to claim 1 with water and other components, and ii) a step of baking or boiling.

24. A method of manufacturing healthy food products, comprising
i) a step of mixing the okara concentrate of claim 1 with water and with another component in a mass ratio of from 1/10 to 10/1, wherein said component is selected from the group consisting of flour, gluten, starch, whole or milled seeds, dried soy milk and a mixture thereof;
ii) optionally a step of adding an amount according to the need of a component selected from the group consisting of baking powder, calcium carbonate, sucrose, sweetener, dried yeast, spices, flavors, and a mixture thereof; and
iii) a step selected from baking, boiling, and drying, or their combination.

25. The method of claim 21, wherein said food products are nutritionally balanced food blends.

26. The method according to claim 24, wherein said food products are selected from the group consisting of bread, bagels, snacks, crackers, granola bars, tortillas, pasta, cereal products, patties, meatballs, sausages, fish sticks, and beverages.

27. The method according to claim 21, wherein said food products are selected from the group consisting of bread, bagels, snacks, crackers, granola bars, tortillas, pasta, cereal products, patties, meatballs, sausages, fish sticks, and beverages.

28. The method according to claim 24, wherein said food products are simulated meat products.

29. A food product comprising the okara concentrate prepared according to claim 12, the product being selected from mixes and premixes to be used as raw materials or intermediates in further production.

30. A food product comprising the okara concentrate prepared according to claim 12, the product being selected from bread, bagels, snacks, crackers, granola bars, tortillas, pasta, cereal products, patties, meatballs, sausages, fish sticks, and beverages.

31. An okara concentrate according to claim 1, wherein said ratio gluten/okara is about 1/10.

32. An okara concentrate according to claim 1, wherein said ratio gluten/okara is about 1/3.

33. A food product, being Okara Bagels, prepared by baking a paste consisting of about 30 wt % of the okara concentrate of claim 32, which concentrate contains about 10 wt % moisture, about 23 wt % wheat flour, about 1 wt % additives including yeast, and about 46 wt % water.

34. A food product, being Okara Crackers, prepared by baking a paste comprising about 30 wt % of the okara concentrate of claim 32, which concentrate contains about 10 wt % moisture, about 20-25 wt % flour, and about 45 wt % water.
